(19) United States
(12) Patent Application Publication
(10) Pub. No.: US 2023/0077371 A1
(43) Pub. Date: Mar. 16, 2023

(54) CURABLE COMPOSITION, CURABLE INK, COMPOSITION CONTAINER, DEVICE FOR FORMING TWO-DIMENSIONAL OR THREE-DIMENSIONAL IMAGE, METHOD OF FORMING TWO-DIMENSIONAL OR THREE-DIMENSIONAL IMAGE, CURED MATTER, AND DECORATIVE OBJECT

(71) Applicant: Masahide KOBAYASHI, Kanagawa (JP)

(72) Inventor: Masahide KOBAYASHI, Kanagawa (JP)

(73) Assignee: Ricoh Company, Ltd., Tokyo (JP)

(21) Appl. No.: 17/821,218

(22) Filed: Aug. 22, 2022

(30) Foreign Application Priority Data
Sep. 2, 2021 (JP) 2021-143458

(51) Int. Cl. C09D 11/101; C09D 11/38; B33Y 10/00; B33Y 70/00; B41M 5/00; B41M 7/00; B29C 64/129; B33Y 30/00; B29C 64/264

(52) U.S. Cl. CPC C09D 11/101; C09D 11/38; B33Y 10/00; B33Y 70/00; B41M 5/0023; B41M 7/0081; B29C 64/129; B33Y 30/00; B29C 64/264; B29K 2105/0002

(57) ABSTRACT

A curable composition contains a polymerizable compound (A), a hydrogen abstracting polymerization initiator (B) represented by the following Chemical Formula 1, a photodegradable polymerization initiator (C), and a hydrogen donor (D), wherein the proportion of the hydrogen abstracting polymerization initiator (B) to the entire of the curable composition is from 0.1 to 10 percent by mass and the proportion of the hydrogen donor (D) to the entire of the hydrogen abstracting polymerization initiator (B) is from 30 to 100 percent by mass,

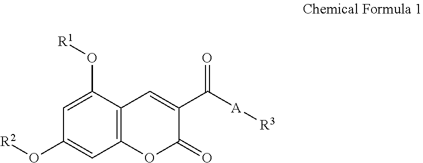

where A represents a phenylene group, a naphthylene group, or a biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

### CROSS-REFERENCE TO RELATED APPLICATIONS

This patent application is based on and claims priority pursuant to 35 U.S.C. § 119 to Japanese Patent Application Nos. 2021-143458, filed on Sep. 2, 2021, in the Japan Patent Office, the entire disclosure of which is hereby incorporated by reference herein.

### BACKGROUND

### Technical Field

The present disclosure relates to a curable composition, a curable ink, a composition container, a device for forming a two or three dimensional image, a method of forming a two-dimensional or three-dimensional image, cured matter, and a decorative object.

### Description of the Related Art

Radically polymerizable inks and cationically polymerizable inks are used in an inkjet printing employing an active energy ray curable composition. Of the two, the radically polymerizable ink is widely used in terms of the production cost and storage stability of the ink.

The radically polymerizable ink as the active energy ray curable ink contains a polymerizable monomer such as an acrylic acid ester and a polymerization initiator that produces a radical at exposure to active energy radiation.

The active energy ray curable composition is required to have good productivity and surface curability and produce highly hard cured matter with good handle of ease.

In addition, the light source of an active energy ray curable composition has been recently changing from a mercury lamp and a metal halide lamp to a light-emitting diode (LED) to protect the environment. Also, a composition is needed which sufficiently cures with little yellowing as a result of photopolymerization reaction occurring when the composition is irradiated with a light emitting diode (LED) with an integrated light quantity of 2.0 J/cm² or less in terms of the production efficiency.

### SUMMARY

According to embodiments of the present disclosure, provided is a curable composition which contains a polymerizable compound (A), a hydrogen abstracting polymerization initiator (B) represented by the following Chemical Formula 1, a photodegradable polymerization initiator (C), and a hydrogen donor (D), wherein the proportion of the hydrogen abstracting polymerization initiator (B) to the entire of the curable composition is from 0.1 to 10 percent by mass and the proportion of the hydrogen donor (D) to the entire of the hydrogen abstracting polymerization initiator (B) is from 30 to 100 percent by mass,

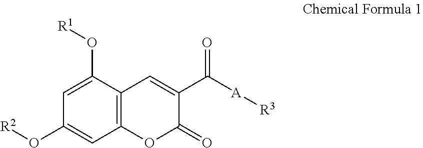

where A represents a phenylene group, a naphthylene group, or a biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an embodiment of an image forming device equipped with an inkjet discharging device:

FIG. 2 is a schematic diagram illustrating an embodiment of another image forming device (device for fabricating a three-dimensional image); and

FIGS. 3A, 3B, 3C, and 3D are schematic explanatory diagrams illustrating an example of a method of solid free-form fabrication using a curable composition.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a composition is provided from which a highly hard cured matter is produced while having a low viscosity and a high level of surface curability with little yellowing.

Embodiments of the present disclosure are described below. The following is a description for illustration purpose only and the present disclosure is not limited thereto.

Curable Composition

The curable composition (hereinafter, simply referred to as a composition) of the present disclosure contains a polymerizable compound (A), a hydrogen abstracting polymerization initiator (B) represented by the following Chemical Formula 1, a photodegradable polymerization initiator (C), and a hydrogen donor (D). The proportion of the hydrogen abstracting polymerization initiator (B) to the entire of the curable composition is from 0.1 to 10 percent by mass and the proportion of the hydrogen donor (D) to the entire of the hydrogen abstracting polymerization initiator (B) is from 30 to 100 percent by mass. The curable composition of the present disclosure may furthermore optionally include other components.

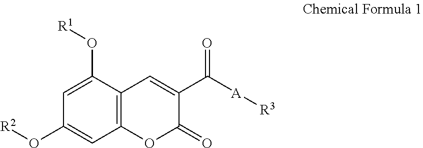

In Chemical Formula 1, A represents a phenylene group, naphthylene group, or biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

The present disclosure was formulated based on the knowledge that a hydrogen abstracting polymerization initiator is significantly inferior to a typical initiator regarding curability except for that of the surface of cured matter obtained using the hydrogen abstracting polymerization initiator and the initiator has a light absorption in the wavelength range of from 350 to 420 nm, causing the cured matter to yellow.

Moreover, cured film manufactured by using a hydrogen abstracting polymerization initiator such as benzophenone as polymerization initiator does not strike a balance between the surface curability and hardness. Furthermore, cured film yellows when manufactured by using a hydrogen abstracting polymerization initiator as polymerization initiator such as thioxanthone having a light absorption in the wavelength range of from 350 to 420 nm, which is the wavelength range of a commonly used LED. Such an initiator is not suitable to prepare clear film. Conversely, film leaves tuck on the surface if it is manufactured with a typical photodegradable initiator alone, failing to obtain a hard surface.

In order to solve the issues mentioned above, the inventors of the present invention have made a composition that contains a polymerizable compound (A), a hydrogen abstracting polymerization initiator (B) represented by the Chemical Formula 1 illustrated above, a photodegradable polymerization initiator (C), and a hydrogen donor (D), wherein the proportion of the hydrogen abstracting polymerization initiator (B) to the entire of the curable composition is from 0.1 to 10 percent by mass, wherein the proportion of the hydrogen donor (D) to the entire of the hydrogen abstracting polymerization initiator (B) is from 30 to 100 percent by mass, to achieve a low viscosity, less yellowing, a high level of curability, and a high hardness.

As the curable composition of the present disclosure, compositions such as a thermocurable composition, an active energy ray curable composition can be used. Of these, the active energy ray curable composition is more suitable.

Hydrogen Abstracting Polymerization Initiator (B)

The hydrogen abstracting polymerization initiator (B) is represented by the following Chemical Formula 1.

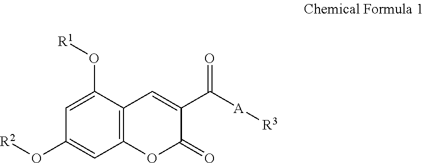

In Chemical Formula 1, A represents a phenylene group, naphthylene group, or biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

Specific examples of the compound represented by Chemical formula 1 include, but are not limited to, 5,7-dimethoxy-3-(4-methylbenzoyl)coumarin, 5,7-dimethoxy-3-(4-ethylbenzoyl)coumarin, 5,7-dimethoxy-3-(4-isopropylbenzoyl)coumarin, 5,7-dimethoxy-3-(4-butylbenzoyl)coumarin, 5,7-dimethoxy-3-(4-(1-methylhexyl)benzoyl)coumarin, 5,7-dimethoxy-3-(4-(1-ethylhexyl)benzoyl)coumarin, 5,7-dimethoxy-3-(4-(1-propylhexyl)benzoyl)coumarin, 5,7-dimethoxy-3-(4-(1-butylhexyl)benzoyl)coumarin, 5,7-dimethoxy-3-(4-(1-propylheptyl)benzoyl) coumarin, 5,7-dimethoxy-3-(4-(1-butylheptyl)benzoyl) coumarin, 5,7-dimethoxy-3-(4-(1-propylheptyl)benzoyl)coumarin, 5,7-dimethoxy-3-(4-(1-butylheptyl)benzoyl)coumarin, 5,7-dimethoxy-3-(4-(1-hexylheptyl)benzoyl)coumarin, 5,7-dimethoxy-3-(4-(1-heptylheptyl)benzoyl)coumarin, 5,7-dimethoxy-3-(4-(1-butyloctyl)benzoyl)coumarin, 5,7-dimethoxy-3-(4-(1-pentyloctyl)benzoyl)coumarin, 5,7-dimethoxy-3-(4-(1-hexyloctyl)benzoyl)coumarin, 5,7-dimethoxy-3-(4-(1-heptyloctyloctyl)benzoyl) coumarin, 5,7-dimethoxy-3-(4-(1-octyloctyl)benzoyl) coumarin, 5,7-dimethoxy-3-(4-(1-pentylnonyl)benzoyl) coumarin, 5,7-dimethoxy-3-(4-(1-hexylnonyl)benzoyl) coumarin, 5,7-dimethoxy-3-(4-(1-heptylnonyl)benzoyl) coumarin, 5,7-diethoxy-3-(4-(4-pentylphenyl)benzoyl) coumarin, and 5,7-dimethoxy-3-(6-methoxy-2-naphthoyl)coumarin. These can be used alone or in combination.

Photodegradable Polymerization Initiator (C)

The photodegradable polymerization initiator (C) of the present disclosure produces active species such as a radical or cation upon an application of energy of active energy causing cleavage and initiates polymerization of a polymerizable compound such as a monomer or oligomer. The photodegradable polymerization initiator (C) includes a known radical polymerization initiator, cation polymerization initiator, base producing agent, and any combination thereof. Of these, the radical polymerization initiator is preferable.

The photodegradable polymerization initiator (C) includes compounds such as acylphosphineoxide compounds, aromatic oniumchlorides, organic peroxides, thio compounds such as thioxanthone compounds, compounds including thiophenyl groups, hexaarylbiimidazole compounds, ketoxime-esterified compounds, borate compounds, azinium compounds, metallocene compounds, active ester compounds, and compounds having a carbon halogen bond.

Specific examples include, but are not limited to, acetophenone, oligomer [benzene, (1-methylethylnyl)-, homopolymer, ar-(2-hydroxy-2-methyl-1-oxopropyl)derivative] of benzoyl formic acid ethyl2-hydroxy-1-(4-isopropenyl phenyl)-2-methyl propane-1-one (Esacure ONE, manufactured by IGM Resins B.V.), 2-benzyl-2-dimethylamino-1-(4-morpholinophenyl)-butanone-1 (IRGACURE® 369), bis(2,4,6-trimethyl benzoyl)phenylphosphine oxide (IRGACURE® 819), 2,4,6-trimethyl benzoyl)diphenylphosphine oxide (IRGACURE® TPO), polyethylene glycol 200-di(β-4(4-(2-dimethylamino-2-benzyl)butanonylphenyl)piperazine (Omnipol 910, manufactured by IGM Resins B.V.).

The proportion of the photodegradable polymerization initiator (C) to the entire composition is preferably from 3 to 20 percent by mass, more preferably from 5 to 15 percent by mass, and furthermore preferably from 5 to 10 percent by mass.

A combinational use of the photodegradable polymerization initiator facilitates adjusting the curability and viscosity of the composition to suit to a particular application.

Hydrogen Donor (D)

The composition of the present disclosure initiates polymerization due to the hydrogen abstracting polymerization initiator (B) and the photodegradable polymerization initiator (C). That is, a compound having structure such as a 3-ketocoumarin backbone is brought into an excited state at exposure to light. Thereafter, the excited molecule abstracts a hydrogen from a nearby compound, which produces a radical on the compound from which the hydrogen has been abstracted and becomes the initiation point of radical polymerization. As a result, the compound having a structure such as a 3-ketocoumarin backbone functions as a photoradical polymerization initiator. That is, if a compound from which hydrogen can be abstracted is present together with a compound having a structure such as a 3-ketocoumarin backbone, polymerization starts by the above-described polymerization initiation mechanism. Therefore, if hydrogen is abstracted from the radically polymerizable compound used in the present disclosure, polymerization may start therefrom.

In addition, the composition of the present disclosure can be present together with the hydrogen donor (D) from which hydrogen is readily abstracted. In that case, hydrogen is transferred more smoothly from the hydrogen donor to the compound molecule having a structure such as a benzophenone backbone excited at exposure to light, thereby enhancing the efficiency of polymerization.

The hydrogen donor (D) used in the present disclosure smoothly supplies hydrogen to a compound molecule having a structure such as benzophenone backbone excited at exposure to light.

The hydrogen donor (D) is preferably the compound represented by the following Chemical Formula 2 or Chemical Formula 3.

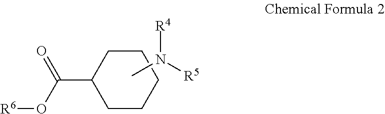

In Chemical Formula 2, R⁴ and R³ each, independently represent hydrogen atoms or linear or branched alkyl groups having 1 to 4 carbon atoms and R⁶ represents a linear or branched alkyl group having 1 to 10 carbon atoms,

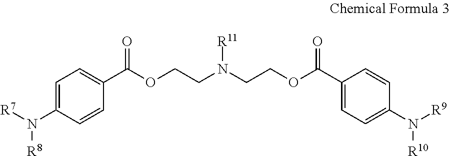

In Chemical Formula 3, R⁷, R⁸, R⁹ and R¹⁰ each, independently represent hydrogen atoms or linear or branched alkyl groups having 1 to 4 carbon atoms and R¹¹ represents a linear or branched alkyl group having 1 to 10 carbon atoms.

The hydrogen donor (D) particularly preferably includes compounds bearing an amino group in terms that the energy required to transfer hydrogen is low. Of these, more preferred specific examples include, but are not limited to, 2-(N,N-dimethylamino) methyl benzoate, 4-(N,N-dimethylamino) ethyl benzoate, 4-(N,N-diethylamino) ethyl benzoate, bis-N,N-[4-dimethylaminobenzoyl)oxyethylene-1-yl]-methyl amine (Esacure A198, manufactured by IGM Resins B.V.), a mixture (Speedcure 7040, manufactured by Lambson Group Ltd.) of 1,3-di({α-4-(dimethylamino)benzoylpoly[oxy(1-methylethylene)]}oxy)-2,2-bis({α-4-(dimethylamino)benzoylpoly[oxy(1-methylethylene)]oxymethyl) propane and {α-4-(dimethylamino)benzoylpoly(oxyethylene)-poly [oxy(1-methylethylene))]-poly(oxyethylene)4-(dimethylamino)benzoate, and polyethylene glycol (200)bis)4-dimethylamino methyl benzoate (Ominopol ASA, manufactured by IGM Resins B.V.).

The proportion of the hydrogen donor (D) to the radically polymerizable compound in the photopolymerizable composition is from 1 to 100 percent by mass and preferably from 50 to 100 percent by mass.

The proportion of the sum of the hydrogen abstracting polymerization initiator (B) and the hydrogen donor (D) to the entire of the curable composition is preferably 10 percent by mass or less and more preferably 2 percent by mass or less.

When the sum of the content of the hydrogen abstracting polymerization initiator (B) and the hydrogen donor (D) surpasses 10 percent by mass or more, yellowing becomes apparent, which damages the original color.

Polymerizable Compound A

The polymerizable compound (A) is not particularly limited and can be suitably selected to suit to a particular application as along as it is polymerized at exposure to active energy rays such as ultraviolet and electron beams. The polymerizable compound (A) can be used alone or in combination to adjust properties such as the reaction rate, ink properties, and cured film properties.

Examples of the polymerizable compounds include, but are not limited to, radically polymerizable compounds and polymerizable oligomers.

Specific examples of the radically polymerizable compound include, but are not limited to, (meth)acrylates, (meth)acrylicamides, and aromatic vinyls. These can be used alone or in combination. (Meth)acrylate means at least one of acrylate and methacrylate and (meta)acrylic means at least one of the acrylic and methacrylic in the present specification.

(Meth)Acrylate

Examples of the (meth)acrylates include, but are not limited to, mono-functional (meth)acrylates, bi-functional (meth)acrylates, tri-functional (meth)acrylates, tetrafunctional (meth)acrylates, pentafunctional (meth)acrylates, and hexafunctional (meth)acrylates. These can be used alone or in combination.

The monofunctional (meta)acrylates include, but are not limited to, tetrahydrofurfuryl(meth)acrylate, hexyl(meta)acrylate, 2-ethylhexyl(meta)acrylate, tert-octyl (meta)acrylate, isoamyl(meta)acrylate, decyl(meta)acrylate, isodecyl(meta)acrylate, stearyl(meta)acrylate, isostearyl (meth)acrylate, cyclohexyl(meta)acrylate, 4-n-butylcyclohexyl(meta)acrylate, boronyl(meta)acrylate, isoboronyl(meta)acrylate, benzyl(meta)acrylate, butoxyethyl (meta)acrylate, 2-chloroethyl (meta)acrylate, 4-bromobutyl(meta)acrylate, cyanoethyl(meta)acrylate, benzyl(meta)acrylate, butoxymethyl(meta)acrylate, 3-methoxybutyl(meta)acrylate, alkoxymethyl(meta)acrylate, alkoxyethyl(meta)acrylate, 2-(2-methoxyethoxy)ethyl(meth)acrylate, 2-(2-butoxyethoxy)ethyl(meth)acrylate, 2, 2, 2-tetrafluoroethyl (meta)acrylate, 1H, 1H, 2H, 2H-perfluorodecyl (meta)acrylate, 4-butylphenyl(meta)acrylate, phenyl(meta)acrylate, 2, 4, 5-tetramethylphenyl(meta)acrylate, 4-chlorophenyl(meta)acrylate, phenoxymethyl(meta)acrylate, phenoxyethyl(meta)acrylate, glycidyl(meta)acrylate, glycidyloxydibutyl(meth)acrylate, glycidyloxyethyl(meth)acrylate, glycidyloxypropyl(meta)acrylate, hydroxyalkyl(meta)acrylate, 2-hydroxyethyl(meta)acrylate, 3-hydroxypropyl(meta)acrylate, 2-hydroxypropyl(meta)acrylate, 2-hydroxybutyl(meth)acrylate, 4-hydroxybutyl(meth)acrylate, dimethylaminoethyl(meta)acrylate, diethylaminoethyl(meta)acrylate, dimethylaminopropyl(meta)acrylate, diethylaminopropyl(meta)acrylate, trimethoxysilylpropyl(meta)acrylate, trimethylsilyl propyl(meta)acrylate, polyethylene oxide monomethylether(meta)acrylate, oligoethylene oxide monomethylether(meta)acrylate, polyethylene oxide(meta)acrylate, oligoethylene oxide(meta)acrylate, oligoethylene oxide monoalkylether(meta)acrylate, polyethylene oxide monalkylether(meta)acrylate, dipropylene glycol(meta)acrylate, polypropylene oxide monoalkylether(meth)acrylate, oligopropylene oxide monoalkylether(meth)acrylate, 2-methacryloyloxy methyl succinate, 2-methacryloxy hexahydrophthalate, 2-methacryloyloxyethyl-2-hydroxypropyl phthalate, butoxy diethyleneglycol(meta)acrylate, trifluoroethyl(meta)acrylate, perfluorooctyl ethyl(meth)acrylate, 2-hydroxy-3-phenoxypropyl(meth)acrylate, ethylene oxide-modified phenol(meta)acrylate, ethylene oxide-modified crezole(meta)acrylate, ethylene oxide-modified nonylphenol (meta)acrylate, propylene oxide-modified nonyl phenol(meta)acrylate, ethylene oxide-modified-2-ethylhexyl (meta)acrylate, acrylic acid-2-(2-vinyloxyethoxy)ethyl, and benzyl acrylate. These can be used alone or in combination.

Of these acrylates, phenoxyethyl(meta)acrylate, benzyl acrylate, acrylic acid-2-(2-vinyloxyethoxy)ethyl, 2-hydroxyethyl(meta)acrylate, 3-hydroxypropyl(meta)acrylate, 2-hydroxypropyl(meth)acrylate, and 4-hydroxybutyl (meth)acrylate are preferable to achieve low viscosity, low level of odor, and good curability. Phenoxyethyl(meta)acrylate, benzylacrylate, and acrylic acid-2-(2-vinyloxyethoxy)ethyl are particularly preferable in terms of the compatibility with a photopolymerization initiators and other monomers.

Specific examples of the bi-functional (meth)acrylates include, but are not limited to, 1,6-hexanediol di(meth)acrylate, 1,10-decanediol di(meth)acrylate, neopentylglycol di(meth)acrylate, 2,4-dimethyl-1,5-pentane diol di(meth)acrylate, butylethylpropane diol di(meth)acrylate, ethoxylated cyclohexanemethanol di(meth)acrylate, 2-ethyl2-butyl-butanediol di(meth)acrylate, hydroxy pivalic acid neopentylglycol di(meth)acrylate, bisphenol F polyethoxy di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, and tricyclodecane di(meth)acrylate. These can be used alone or in combination.

Specific examples of the tri-functional (meta)acrylates include, but are not limited to, alkylene oxide-modified tri(meta)acrylate of trimethylol propane tri(meta)acrylate, trimethylolethane tri(meta)acrylate, and trimethylolpropane, pentaerythritol tri(meta)acrylate, dipentaerythritol tri(meta)acrylate, trimethylol propane tri((meta)acryloyloxy propyl)ether, alkylene oxide-modified tri(meta)acrylate isocyanurate, dipentaerythritol tri(meta)acrylate propionate, tri(meth)acryloyloxyethyl isocyanulate, hydroxy pivalaldehyde-modified dimethylol propane tri(meth)acrylate, sorbitol tri(meth)acrylate, propoxylated trimethylol propane tri(meta)acrylate, and ethoxylated glycerin tri(meta)acrylate. These can be used alone or in combination.

Specific examples of the tetra-functional (meth)acrylates include, but are not limited to, sorbitol tetra(meth)acrylate, ditrimethylol propanetetra(meth)acrylate, and dipentaerythritol tetra(meth)acrylate propionate. These can be used alone or in combination.

A specific example of the penta-functional (meth)acrylates is sorbitol penta(meth)acrylate. These can be used alone or in combination.

Specific examples of the hexa-functional (meth)acrylates include, but are not limited to, dipentaerythritol hexa(meth)acrylate, sorbitol hexa(meth)acrylate, alkyleneoxide-modified hexa(meth)acrylate of phosphazene, and caprolactone-modified dipentaerythritol hexa(meth)acrylate. These can be used alone or in combination.

Aromatic Vinyl Compound

Specific examples include, but are not limited to, styrene, methyl styrene, dimethyl styrene, trimethyl styrene, ethyl styrene, isopropyl styrene, chloromethyl styrene, methoxy styrene, acetoxy styrene, chloro styrene, dichloro styrene, bromo styrene, vinyl benzoate methylester, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethylhexyl) styrene, 4-(2-ethylhexyl) styrene, allyl styrene, isopropenyl styrene, butenyl styrene, octenyl styrene, 4-t-butoxy carbonyl styrene, 4-methoxy styrene, and 4-t-butoxy styrene. These can be used alone or in combination.

Polymerizable Oligomer

The polymerizable oligomer preferably has one or more ethylenyl unsaturated double bonds. Oligomer means a polymer having 2 to 20 repeating monomer structural units.

The weight average molecular weight of the polymerizable oligomer has no particular limit and can be suitably selected to suit to a particular application. It is preferably from 1,000 to 30,000 and preferably from 5,000 to 20,000 in polystyrene conversion. The weight average molecular weight can be measured by gel permeation chromatography (GPC).

Specific examples of the polymerizable oligomer include, but are not limited to, urethaneacrylate oligomers such as aromatic urethane acrylate oligomer and aliphatic urethane acrylate oligomer, epoxy acrylate oligomer, polyester acrylate oligomer, and other special oligomers. These can be used alone or in combination. Of these oligomers, oligomers having 2 to 5 unsaturated carbon-carbon bond are preferable and oligomers having 2 unsaturated carbon-carbon bond are more preferable. Oligomers having 2 to 5 unsaturated carbon-carbon bonds have good curability.

The proportion of the urethane acrylate oligomer to the entire composition is preferably 5 percent by mass or less to reduce viscosity.

The polymerizable oligomer can be procured.

Specific examples include, but are not limited to, UV-2000B, UV-2750B, UV-3000B, UV-3010B, UV-3200B, UV-32000B, and UV-3300B, UV-3700B, UV-6640B, UV-8630B, UV-7000B. UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (all manufactured by The Nippon Synthetic Chemical Industry Co., Ltd.), CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971 A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (all manufactured by Sartomer Company), EBECRYL210, EBECRYL220, EBECRYL230, EBECRYL270, KRM8200, EBECRYL4666, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270. EBECRYL8311, and EBECRYL8701 (all manufactured by Daicel Cytec). These can be used alone or in combination.

Synthetic polymerizable oligomers can be used; a synthetic polymerizable oligomer and a procured polymerizable oligomer can be used in combination.

Examples of the polymerizable compound (A) include, but are not limited to, a urethane (meth)acrylate derivative obtained by reacting a compound having an isocyanate group with a (meth)acrylic acid ester having a hydroxyl group and an epoxy (meth)acrylate derivative obtained by reacting (meth)acrylic acid with a compound having an epoxy group.

In addition to the derivatives of (meth)acrylic acid derivative, N-vinyl compounds such as N-vinylcaprolactam, N-vinylpyrrolidone, and N-vinylformamide, aromatic vinyl compounds such as styrene and α-methylstyrene, vinyl ethers such as diethylene glycol divinyl ethers, triethylene glycol divinyl ether, and cyclohexane dimethanol divinyl ether, and allyl compounds such as allyl glycidyl ether, diallyl phthalate, and triallyl trimellitate can be used.

The proportion of the polymerizable compound (A) in the composition is preferably from 50.0 to 95.0 percent by mass and more preferably from 70.0 to 90.0 percent by mass. The polymerizable compound (A) can be used alone or in combination.

By adjusting the content of the polymerizable compound (A), the curability and viscosity of the composition and the hardness and attachability of cured matter can be readily adjusted to suit to a particular application.

Acrylamide Compound (A1)

The acrylamide compound (A1) includes an acrylamide group and an ester framework.

The molecular weight of the acrylic amide compound (A1) is preferably from 150 to 200. A molecular weight of 150 or more can minimize the odor produced at volatilization of the compound and enhance the inkjet discharging stability, which is preferable. A molecular weight of 250 or less enhances the curability of the composition, improves the strength of the cured matter, and increases the viscosity of the composition.

In the specification of the present disclosure, (meth)acrylic acid ester means an acrylic acid ester or a methacrylic acid ester. (Meth)acrylate means acrylate or methacrylate.

The acrylamide compound (A1) is preferably a compound represented by the following Chemical Formula 4 or 5.

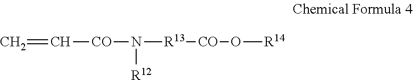

In Chemical Formula 4, R¹² represents a hydrogen atom or an alkyl group having a linear or branched chain having one to four carbon atoms, R¹³ represents an alkyl group having a linear or branched chain having one to four carbon atoms. R¹⁴ represents an alkyl group having a linear or branched chain having one to four carbon atoms. The total number of carbon atoms of R¹², R¹³, and R¹⁴ is from 2 to 6,

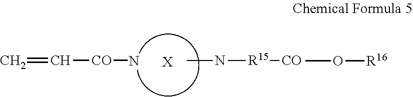

In Chemical Formula 5, the ring X represents a ring structure having 2 to 5 carbon atoms including a nitrogen atom, R¹⁵ represents a single bond or a linear or branched alkylene group having 1 to 3 carbon atoms, R¹⁶ represents a linear or branched alkyl group having 1 to 3 carbon atoms. In Chemical Formula 5, the total number of the carbon atoms of the ring X, R¹⁵, and R¹⁶ is 3 to 6.

Examples of the compound represented by Chemical Formula 4 or 5 include, but are not limited to, N-acryloyl-N-alkyl amino acid alkyl ester (including N-acryloyl proline alkyl ester), and N-acryloyl piperidine carboxylic acid alkyl ester. The alkyl group in this paragraph means a linear or branched alkyl group having 1 to 4 carbon atoms and particularly preferably an alkyl group having 1 or 2 carbon atoms (that is, a methyl group or an ethyl group).

The N-acryloyl-N-alkyl amino acid alkyl ester is not particularly limited and can be suitably selected to suit to a particular application. Specific examples include, but are not limited to, N-acryloyl-N-methylglycine methyl ester, N-acryloyl-N-methylglycine ethyl ester, N-acryloyl-N-methylglycine propyl ester, N-acryloyl-N-methylglycine butyl ester, N-acryloyl-N-ethylglycine methyl ester. N-acryloyl-N-ethylglycine ethyl ester, N-acryloyl-N-ethylglycine propyl ester, N-acryloyl-N-propylglycine methyl ester, N-acryloyl-N-propylglycine ethyl ester, N-acryloyl-N-butylglycine methyl ester, N-acryloyl-N-methylalanine methyl ester, N-acryloyl-N-methylalanine ethyl ester, N-acryloyl-N-methylalanine propyl ester, N-acryloyl-N-ethylalanine methyl ester, N-acryloyl-N-ethylalanine ethyl ester, N-acryloyl-N-propylalanine methyl ester, N-acryloyl-N-methyl-β-alanine methyl ester, N-acryloyl-N-methyl-β-alanine ethyl ester, N-acryloyl-N-ethyl-β-alanine methyl ester, N-acryloyl-N-ethyl-β-alanine ethyl ester, N-acryloyl-N-methyl valine methyl ester, N-acryloyl-proline methyl ester, and N-acryloyl-proline ethyl ester. These can be used alone or in combination.

The N-acryloyl piperidine carboxylic acid alkyl ester is not particularly limited and can be suitably selected to suit to a particular application. Specific examples include, but are not limited to, N-acryloyl piperidine-2-carboxylic acid methyl ester, N-acryloyl piperidine-3-carboxylic acid methyl ester, and N-acryloyl piperidine-4-carboxylic acid methyl ester. These can be used alone or in combination.

The acrylamide compound (A1) is preferably a colorless transparent or pale yellow transparent liquid having a low viscosity (100 mPa·s or less) at room temperature (25 degrees C.) for application to an inkjet recording method. In addition, for the safety of a user, it is preferable that the compound do not demonstrate strong acidity or basic or be free of an impurity such as a harmful formaldehyde.

Many acrylamide compounds bearing a polymerizable acrylamide group and free of an ester structure can be procured (e.g., N-acryloylmorpholine, N,N-dimethylacrylamide, N,N-diethylacrylamide, N-isopropylacrylamide, N-(2-hydroxyethyl)acrylamide, N-(hydroxymethyl)acrylamide, N-(butoxymethyl)acrylamide, N-[3-(dimethylamino)propyl]acrylamide, N-(1,1-dimethyl-3-oxobutyl) acrylamide, 2-acrylamide-2-methylpropane sulfonic acid, etc.). However, it is difficult to find an acrylamide compound demonstrating all the effects of the present disclosure. The inventors of the present invention have found that inclusion of the acrylamide compound (A1) having an ester structure with a moderate polarity in neutral state demonstrates the effects of the present disclosure.

The proportion of the acrylamide compound (A1) to the entire of a composition is preferably from 50.0 to 90.0 percent by mass.

Coloring Material

The composition of the present disclosure may contain a coloring agent. Pigments and dyes can be added as a coloring material in accordance with the objectives and requisites of the composition of the present disclosure. These demonstrate black, white, magenta, cyan, yellow, green, orange, and gloss color such as gold and silver.

The content of the coloring material is not particularly limited and determined considering the desired color density and dispersibility of the coloring material of the composition. It is preferable that the proportion of the coloring material of the total amount of the composition be preferably from 0.1 to 20 percent by mass. The composition of the present disclosure can be clear and colorless without containing a coloring material. If so, the composition is suitable as an overcoat layer to protect an image. An inorganic or organic pigment can be used alone or in combination as the pigment.

Specific examples of the inorganic pigment include, but are not limited to, carbon blacks (C.I. PIGMENT BLACK 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene pigments, perinone pigments, anthraquinone pigments, quinacridone pigments, dioxane pigments, thioindigo pigments, isoindolinone pigments, and quinofuranone pigments, dye chelates such as basic dye type chelates and acid dye type chelates, dye lakes such as basic dye type lake and acid dye type lake, nitro pigments, nitroso pigments, aniline black, and daylight fluorescent pigments.

In addition, the coloring material may furthermore optionally contain a dispersant to enhance the dispersibility of the pigment. The dispersant has no particular limit. For example, it is suitable to use a polymer dispersant conventionally used to prepare a pigment dispersion.

The dye includes, for example, an acidic dye, direct dye, reactive dye, basic dye, and a combination thereof.

Organic Solvent

The composition of the present disclosure may include an organic solvent, but if possible, it is preferred that the composition be free of an organic solvent.

A composition free of an organic solvent, in particular a volatile organic compound (VOC), is preferable because it enhances safeness at places where the composition is handled, thereby preventing the environment contamination. “Organic solvent” represents a non-reactive organic solvent such as ether, ketone, xylene, ethylacetate, cyclohexanone, or toluene, which is clearly distinguished from a reactive monomer. Furthermore, “free of” an organic solvent means that no organic solvent is substantially contained. The proportion thereof is preferably less than 0.1 percent by mass.

Other Components

The composition of the present disclosure may furthermore optionally include other known components. The other components are not particularly limited. Examples are known agents such as surfactants, polymerization inhibitors, leveling agents, defoaming agents, fluorescent brighteners, penetration-enhancing agents, wetting agents (humectants), fixing agents, viscosity stabilizers, fungicide, preservatives, antioxidants, ultraviolet absorbents, chelate agents, pH regulator, and thickeners.

Preparation of Composition

The composition of the present disclosure can be prepared by using the components mentioned above. The preparation devices and conditions are not particularly limited. For example, the curable composition can be prepared by loading a polymerizable monomer, a pigment, a dispersant, and others into a dispersing machine such as a ball mill, a kitty mill, a disk mill, a pin mill, and a DYNO-MILL to prepare a pigment liquid dispersion followed by mixing with a polymerizable monomer, an initiator, a polymerization inhibitor, and a surfactant.

Viscosity

The viscosity of the composition of the present disclosure has no particular limit and it can be adjusted to suit to a particular application and device. For example, for a discharging device that discharges the composition from nozzles, the viscosity thereof is 60 mPa·s or less, preferably in the range of from 3 to 40 mPa·s, more preferably from 5 to 30 mPa·s, furthermore preferably from 5 to 15 mPa·s, and particularly preferably from 6 to 12 mPa·s in the temperature range of from 20 to 65 degrees C., preferably at 25 degrees C.

In addition, it is particularly preferable to satisfy this viscosity range without containing the organic solvent mentioned above. Viscosity can be measured by a cone plate type rotary viscometer (VISCOMETER TVE-22L, manufactured by TOKI SANGYO CO., LTD.) using a cone rotor (1° 34′×R24) at a rate of rotation of 50 rpm with a setting of the temperature of hemathermal circulating water in the range of from 20 degrees C. to 65 degrees C. The temperature of the circulating water can be controlled with a VISCOMATE VM-150III.

Curing Device

The device for curing the composition of the present disclosure utilizes curing upon application of heat or active energy. Curing upon application of active energy is preferable.

The active energy for use in curing the composition of the present disclosure is not particularly limited as long as they can apply energy to allow polymerization reaction of the polymerizable components in the curable composition. Specific examples include, but are not limited to, electron beams, α rays, β rays, γ rays, and X rays, in addition to ultraviolet rays. In an embodiment in which a particularly high energy light source is used, polymerization occurs without a polymerization initiator. In addition, mercury-free is strongly preferable to protect the environment when ultraviolet irradiation is used. Using a GaN-based semiconductor ultraviolet light-emitting device is excellent from industrial and environmental points of view. Furthermore, ultraviolet light-emitting diodes (UV-LED) and ultraviolet laser diodes (UV-LD) are preferable as ultraviolet light source because they have small sizes, long working life, and high efficiency, and enjoy high cost performance.

Of these, ultraviolet rays having a peak in the wavelength range of from 285 to 405 nm (preferably from 365 to 405 nm) emitted from an ultraviolet ray emitting diode (hereinafter also referred to as a UV-LED) are preferable in terms of energy saving and miniaturization of the device. The light absorption spectrum of a polymerization initiator is generally broad. Usage of a UV-LED that emits light having a narrow specific wavelength range does not enhance the curability of the composition. Therefore, using the composition of the present disclosure having excellent curability is preferable even when a UV-LED is used.

Application Field

The application field of the composition of the present disclosure is not particularly limited. It can be applied to any field where the active energy ray curable composition is used. For example, the curable composition is selected suit to a particular application and used for a resin for processing, a paint, an adhesive, an insulant, a releasing agent, a coating material, a sealing material, various resists, and various optical materials.

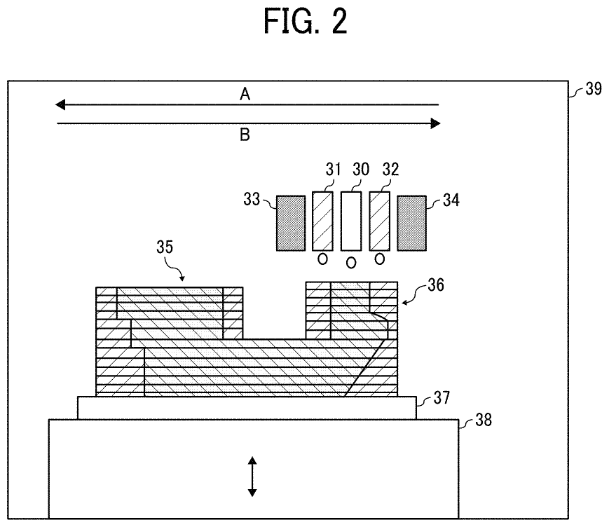

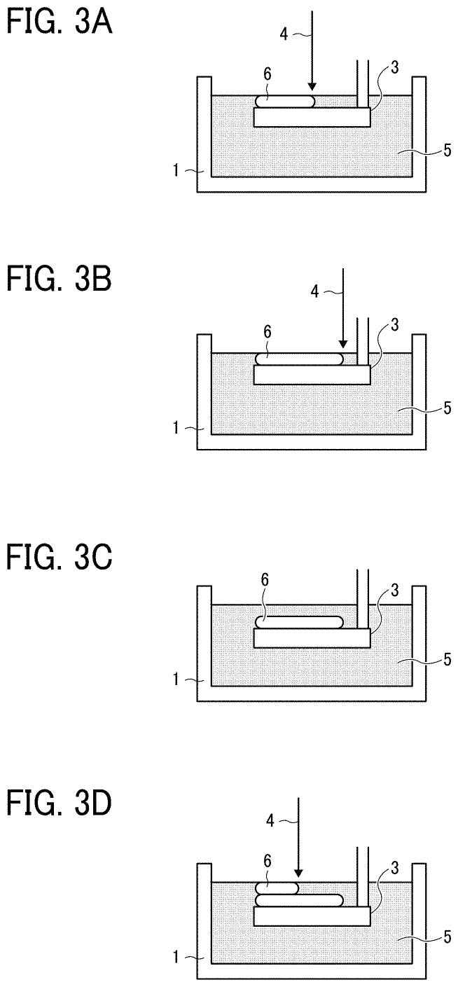

Furthermore, the composition of the present disclosure can be used as an ink to form two-dimensional texts, images, and designed coating film on various substrates and in addition a solid object forming material to form a three-dimensional image (solid freeform fabrication object). This material for solid freeform fabrication can be used as a binder for powder particles for use in powder additive manufacturing for conducting solid freeform fabrication by repeating curing and laminating powder layers. Also, it can be used as a solid constituting material (modeling material) or supporting member (supporting material) for use in additive manufacturing (stereolithography) method as illustrated in FIG. 2 and FIGS. 3A to 3D. FIG. 2 is a diagram illustrating a method of discharging the composition of the present disclosure to a particular area followed by curing upon irradiation of active energy to form a layer and laminating the layers (detail of which is described later). FIGS. 3A to 3D are diagrams illustrating a method of irradiating a pool (accommodating unit) 1 of the composition 5 of the present disclosure with active energy 4 to form a cured layer 6 having a particular form on a movable stage 3 and sequentially laminating the cured layer 6 so that a solid freeform fabrication object is obtained.

A device for fabricating a three-dimensional object using the composition of the present disclosure can be a known device and is not particularly limited. An example of the device includes an accommodating device, a supplying device, and a discharging device of the composition, an active energy ray irradiator and others.

The present disclosure includes a cured product obtained by curing the curable composition and a processed product obtained by processing a structure having the cured product formed on a substrate. The mold product is obtained by subjecting cured matter or structure having a sheet form or film form to molding process such as hot drawing and punching. The molded product is preferably used for items to be molded after surface decoration. They are gauges or operation panels of products such as vehicles, office machines, electric and electronic machines, and cameras.

The substrate is not particularly limited. It can be suitably selected to suit to a particular application. Substances such as paper, fiber, threads, fabrics, leather, metal, plastic, glass, wood, ceramics, or composite materials thereof can be used. Of these, plastic substrates are preferred in terms of processibility.

Accommodating Unit

The accommodating unit of the present disclosure means a container accommodating the composition and is suitable for the applications as described above. For example, if the composition of the present disclosure is used as ink, the accommodating container containing the ink can be used as an ink cartridge or an ink bottle. Therefore, users can avoid direct contact with the ink during working such as transfer or replacement of the ink, so that fingers and clothes are prevented from getting dirty. In addition, the ink is prevented from mixing with foreign matter such as dust. The container can be of any size, any form, and any material. For example, the container can be designed to a particular application. The container is preferably made of a light blocking material for blocking the light or covered with materials such as a light blocking sheet.

Method of Forming Image and Device for Forming Image

The method of forming an image of the present disclosure may employ active energy, heating, and others. The method of forming an image of the present disclosure includes at least irradiating the composition of the present disclosure with active energy to cure the composition. The device for forming an image of the present disclosure includes an irradiator for irradiating the composition of the present disclosure with active energy radiation and an accommodating unit for accommodating the composition of the present disclosure. The accommodating unit may include the container mentioned above. Furthermore, the method and the device may respectively include discharging the curable composition of the present disclosure and a discharging device for discharging the curable composition of the present disclosure.

The method of discharging the curable composition is not particularly limited, including a continuous spraying method and an on-demand method. The on-demand method includes methods such as a piezo method, a thermal method, and an electrostatic method.

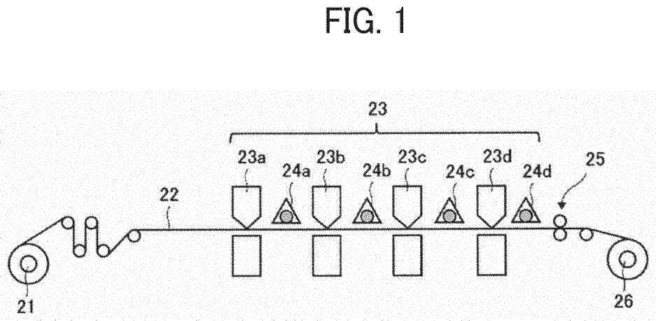

FIG. 1 is a diagram illustrating an image forming device including an inkjet discharging device 20. Printing units 23a, 23b, 23c, and 23d each has an ink cartridge and a discharging head respectively for yellow, magenta, cyan, and black active energy ray curable inks. They discharge the inks onto a substrate (recording medium) 22 fed from a supplying roll 21. Thereafter, light sources (irradiators) 24a, 24b, 24c, and 24d emit active energy rays to the inks to cure them, thereby forming a color image. Thereafter, the recording medium 22 is conveyed to a processing unit 25 and a printed matter reeling roll 26. Each of the printing units 23a, 23b, 23c, and 23d may include a heating assembly for liquidizing the ink at the ink discharging unit. In addition, a mechanism may be optionally disposed which cools down the recording medium to an ambient temperature in a contact or non-contact manner. The inkjet recording method includes a serial method including discharging an ink onto a recording medium that continually moves in accordance with the width of a discharging head while moving the head and a line method including discharging an ink onto a recording medium that continuously moves from a discharging head fixed at a particular position.

The recording medium 22 is not particularly limited. Specific examples thereof include, but are not limited to, paper, film, metal, or complex materials thereof. The recording medium 22 takes a sheet-like form but is not limited thereto. The device for forming an image may have a simplex printing configuration capable of printing an image on one side of a substrate or a duplex printing configuration capable of printing an image on both sides thereof.

In addition, after an image is printed with multiple colors with no or faint active energy radiation from the light sources 24a, 24b, and 24c, the light source 24d exposes the image to active energy radiation. This configuration saves energy and cost.

The print matter printed with the ink of the present disclosure includes items having printed text or images on a plain surface of a medium such as conventional paper and resin film, items having printed text or images on a rough surface, and items having printed text or images on a surface made of various materials such as metal or ceramic. The print matter can make a solid feeling image formed of two-dimensional image portions and three-dimensional image portions or a solid object by laminating two dimensional images.

FIG. 2 is a schematic diagram illustrating another example of the device for forming an image (device for fabricating a three-dimensional image) of the present disclosure. A device for forming an image (image forming device) 39 illustrated in FIG. 2 uses a head unit (movable in the AB direction). In the unis, inkjet heads are arranged to discharge a curable composition from a discharging head unit 30 for fabrication, discharge a composition for support from discharging head units 31 and 32 for support, and irradiate the applied compositions with active energy emitted from irradiators 33 and 34 to form and solidify a fabrication layer. This operation is repeated according to the number of laminations while moving a stage 38 movable up and down, thereby laminating support layers and fabrication layers to manufacture a solid freeform fabrication object 35 including a laminated support 36. Thereafter, a laminated support 36 is removed. Although there is only one discharging head unit 30 for fabrication in FIG. 2, the device may have two or more discharging head units 30.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

Components of Composition

Table 1-1 lists the abbreviations and the names of compounds, manufacturers, and products of the materials for use in preparation of a composition for the polymerizable compound (A) and Table 1-2 lists those for the other components.

The raw materials not available on the market were synthesized according to the methods described in Synthesis Examples 1 to 7 below.

The synthetic compounds were identified by nuclear magnetic resonance spectroscopy (device: JNM-ECX500, manufactured by JEOL Ltd.) and the purity of the compounds was measured by gas chromatography (device: GCMS-QP2010 Plus, manufactured by Shimadzu Corporation). These chemical analyses were conducted by standard methods.

TABLE 1-1

| | | | Manufacturer and |
|---|---|---|---|
| | Abbreviation | Compound or structure | product |
| Polymerizable | A-1 | Phenoxyethyl acrylate | Biscoat #192, |
| compound A | | | manufactured by |
| | | | OSAKA ORGANIC |
| | | | CHEMICAL |
| | | | INDUSTRY LTD. |
| | A-2 | Acryloylmorpholine | ACMO. |
| | | | manufactured by KJ |
| | | | Chemicals |
| | | | Corporation |
| | A-3 | Isobornyl acrylate | IBZA, manufactured |
| | | | by OSAKA |
| | | | ORGANIC |
| | | | CHEMICAL |
| | | | INDUSTRY LTD. |
| | A-4 | Benzyl acrylate | Biscoat #160, BZA, |
| | | | manufactured by |
| | | | OSAKA ORGANIC |
| | | | CHEMICAL |
| | | | INDUSTRY LTD. |
| | A-5 | Tetrahydro furfuryl acrylate | Biscoat #150, |
| | | | THFA, |
| | | | manufactured by |
| | | | OSAKA ORGANIC |
| | | | CHEMICAL |
| | | | INDUSTRY LTD. |
| | A-6 | 4-hydroxybutyl acrylate | 4-HBA, |
| | | | manufactured by |
| | | | OSAKA ORGANIC |
| | | | CHEMICAL |
| | | | INDUSTRY LTD. |
| | A-7 | AOMA | Manufactured by |
| | | | NIPPON |
| | | | SHOKUBAI CO., |
| | | | LTD. |
| | A-8 | Tetrahydrofurfuryl alcohol | Biscoat #150D, |
| | | Acrylic acid multimer ester | manufactured by |
| | | | OSAKA ORGANIC |
| | | | CHEMICAL |
| | | | INDUSTRY LTD. |
| | A-9 | Dichyclopentenyloxy ethylacrylate | FA-512AS, |
| | | | manufactured by |
| | | | Hitachi Chemical |
| | | | Co., Ltd. |
| | A-10 | 1,9-nonane diol diacrylate | Biscoat #260. 1,9- |
| | | | NDDA, |
| | | | manufactured by |
| | | | OSAKA ORGANIC |
| | | | CHEMICAL. |
| | | | INDUSTRY LTD. |
| | A-11 | Acrylic acid 2- | Biscoat #216, |
| | | [{(butylamino)carbonyl}oxy]ethylester | manufactured by |
| | | | OSAKA ORGANIC |
| | | | CHEMICAL |
| | | | INDUSTRY LTD. |
| | A-12 | Glycerine tri-acrylate | M3547, |
| | | | manufactured by |
| | | | TOAGOSEI CO., |
| | | | LTD. |
| | A-13 | Dimethylol-tricyclodecane diacrylate | KAYARAD R-684, |
| | | | manufactured by |
| | | | Nippon Kayaku Co., |
| | | | Ltd. |
| | A-14 | ε-caprolactone-modified dipentaerythritol | KAYARAD DPCA- |
| | | hexaacrylate | 60, manufactured by |
| | | | Nippon Kayaku Co., |
| | | | Ltd. |
| Acrylamide compound (A1) | A1-1 | 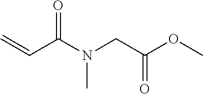 | (Refer to Synthesis Example 1) |
| | A1-2 | 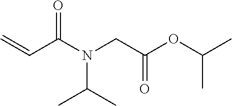 | (Refer to Synthesis Example 2) |
| | A1-3 | 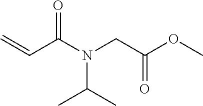 | (Refer to Synthesis Example 3) |
| | A1-4 | 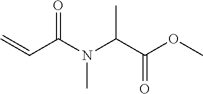 | (Refer to Synthesis Example 4) |
| | A1-5 | 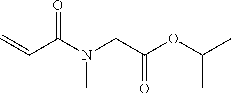 | (Refer to Synthesis Example 5) |
| | A1-6 | 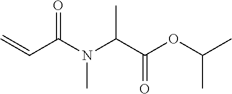 | (Refer to Synthesis Example 6) |
| | A1-7 | 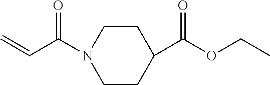 | (Refer to Synthesis Example 7) |

TABLE 1-2

| | | | |
|---|---|---|---|
| Hydrogen abstracting polymerization initiator (B) represented by Chemical Formula 1 | B-1 | 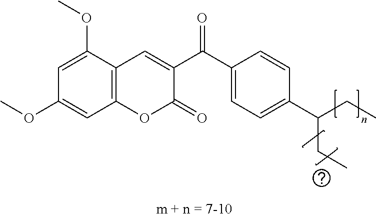 | Esacure 3644, manufactured by IGM Japan Ltd. |
| | B-2 | 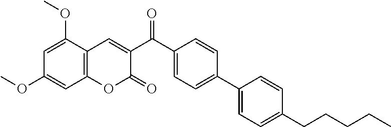 [SMILES: CCCCCc1ccc(-c2ccc(C(=O)c3cc4c(OC)cc(OC)cc4oc3=O)cc2)cc1] | (Refer to Synthesis Example 8) |
| | B-3 | 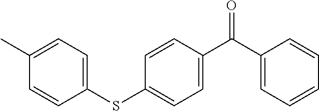 [SMILES: Cc1ccc(Sc2ccc(C(=O)c3ccccc3)cc2)cc1] | (Refer to Synthesis Example 9) |
| Hydrogen abstracting polymerization initiator (B1) other than (B) | B1-1 | 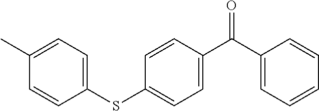 [SMILES: Cc1ccc(Sc2ccc(C(=O)c3ccccc3)cc2)cc1] | 4-benzoyl 4’- methyldiphenyl sulfide (BMS), manufactured by Tokyo Chemical Industry Co., Ltd. |
| | B1-2 | 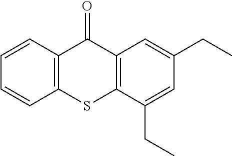 [SMILES: CCc1cc(CC)c2sc3ccccc3c(=O)c2c1] | DETX-s, manufactured by Nippon Kayaku Co., Ltd. |
| Photodegradable | C-1 | 1-hydroxy-cyclobexyl-phenyl-ketone | IRGACURE |
| polymerization | | | 184, |
| initiator (C) | | | manufactured |
| | | | by BASF |
| | | | Japan Ltd. |
| | C-2 | Bis(2,4,6-trimethyl benzoyl)phenylphosphine | IRGACURE |
| | | oxide | 819, |
| | | | manufactured |
| | | | by BASF |
| | | | Japan Ltd. |
| | C-3 | 2,4,6-trimethylbenzoyl-diphenyl-phosphine | IRGACURE |
| | | oxide | TPO, |
| | | | manufactured |
| | | | by BASF |
| | | | Japan Ltd. |
| | C-4 | 2-[4-(methylthio)benzoyl]-2-(4- | IRGACURE |
| | | morpholinyl)propane | 907, |
| | | | manufactured |
| | | | by BASF |
| | | | Japan Ltd. |
| | C-5 | l-[4-(2-hydroxyethoxy)-phenyl]-2-hydroxy-2- | IRGACURE |
| | | methyl-1-propane-1-one | 2959, |
| | | | manufactured |
| | | | by BASF |
| | | | Japan Ltd. |
| | C-6 | Phenyl(2,4,6-trimethyl benzoyl)phosphinic acid | TPO-L, |
| | | ethyl | manufactured |
| | | | by IGM Resins |
| | | | B.V. |
| Hydrogen donor | D-1 | 2-dimethyl amino benzoic acid methyl | manufactured |
| (D) | | | by Tokyo |
| | | | Chemical |
| | | | Industry Co. |
| | | | Ltd. |
| | D-2 | 4-dimethyl amino benzoic acid methyhl | KAYACURE |
| | | | EPA, |
| | | | manufactured |
| | | | by Nippon |
| | | | Kayaku Co., |
| | | | Ltd. |
| | D-3 | Bis-N,N-[4- | Esacure A198, |
| | | (dimethylaminobenzoyl)oxyethylene-1-yl]- | manufactured |
| | | methyl amine | by IGM Resins |
| | | | B.V. |
| | D-4 | Polyethylene glycol (200)bis(4-dimethylamino | Omnipol ASA, |
| | | benzoic acid methyl) | manufactured |
| | | | by IGM Resins |
| | | | B.V. |
| | D-5 | Mixture of 1,3-di(α-4-(dimethylamino)benzoyl poly[oxy(L-methylethylene)]}oxy(-2,2- | Speedcure |
| | | bis({α-4-(dimethylamino)benzoyl poly[oxy(L-methylethylene)]}oxymethylpropane and | 7040, |
| | | (α-4-(dimethylamino)benzoyl poly[oxyethylenen)poly[oxy(L-methylethylene)]- | manufactured |
| | | poly(oxyethylene))4-(dimethylamino)benzoate | by Lambson |
| | | | Group Ltd. |
| Other | Polymerization | 4-methoxyphenol | Methoquinone, |
| components | inhibitor | | manufactured |
| | | | by Seiko |
| | | | Chemical Co., |
| | | | Ltd. |
| | Surfactant | Silicone-based surfactant | BYK-UV3510, |
| | | | manufactured |
| | | | by BYK Japan |
| | | | KK. |

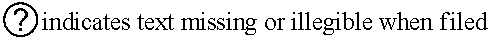

### Synthesis Example 1

### Synthesis of N-acryloyl-N-methylglycine Methyl Ester (A1-1)

A total of 0.30 mol of N-methylglycine methyl ester hydrochloride (reagent, manufactured by Sigma Aldrich Japan Co., Ltd.), 0.45 mol of potassium carbonate (reagent, manufactured by Kanto Chemical Co., Inc.), and 400 mL of water were stirred and mixed at a temperature range of from 0 to 10 degrees C. Thereafter, 0.33 mol of acrylic acid chloride (reagent, manufactured by Wako Pure Chemical Industries. Ltd.) was slowly added dropwise while the temperature was maintained. After completion of the addition and three-time extraction with 400 mL of ethyl acetate (reagent, manufactured by Kanto Chemical Co., Inc.), the resulting liquid including an ethyl acetate layer was rinsed with 400 mL of water. Ethylacetate was distilled away at 40 degrees C. under reduced pressure to obtain 0.20 mol of the target N-acryloyl-N-methylglycine methyl ester (A1-1) as an almost colorless and transparent liquid. Its purity was 98.3 percent by mass.

N-acryloyl-N-methyl glycine methyl ester (A1-1) is a known compound (CAS registration number 72065-23-7) and its molecular weight was 157.2.

### Synthesis Example 2

### Synthesis of N-acryloyl-N-isopropylglycine Isopropyl Ester (A1-2)

A total of 0.22 mol of the target N-acryloyl-N-isopropylglycine isopropyl ester (A1-2) was obtained as an almost colorless and transparent liquid in the same manner as in Synthesis Example 1 except that N-methylglycine methyl ester hydrochloride was changed to N-isopropylglycine isopropyl ester hydrochloride (reagent, manufactured by Tokyo Chemical Industry Co. Ltd.). Its purity was 98.5 percent by mass.

The molecular weight of N-acryloyl-N-isopropyl glycine isopropyl ester (A1-2) was 213.3.

### Synthesis Example 3

### Synthesis of N-acryloyl-N-isopropyl Glycine Methyl Ester (A1-3)

A total of 0.22 mol of the target N-acryloyl-N-isopropylglycine isopropyl ester (A1-3) was obtained as an almost colorless and transparent liquid in the same manner as in Synthesis Example 1 except that N-methylglycine methyl ester hydrochloride was changed to N-methylglycine isopropyl ester hydrochloride (reagent, manufactured by Tokyo Chemical Industry Co. Ltd.). Its purity was 98.5 percent by mass.

The molecular weight of N-acryloyl-N-isopropyl glycine methyl ester (A1-3) was 185.2.

### Synthesis Example 4

### Synthesis of N-acryloyl-N-methyl Alanine Methyl Ester (A1-4)

A total of 0.22 mol of the target N-acryloyl-N-methylalanine methyl ester (A1-4) was obtained as an almost colorless and transparent liquid in the same manner as in Synthesis Example 1 except that N-methylglycine methyl ester hydrochloride was changed to N-methylalanine methyl ester hydrochloride (reagent, manufactured by Tokyo Chemical Industry Co. Ltd.). Its purity was 98.5 percent by mass.

The molecular weight of N-acryloyl-N-methyl alanine methyl ester (A1-4) was 171.2.

### Synthesis Example 5

### Synthesis of N-Acryloyl-N-methylglycine Isopropyl Ester (A1-5)

A total of 0.22 mol of the target N-acryloyl-N-methyl alanine methyl ester (A1-5) was obtained as an almost colorless and transparent liquid in the same manner as in Synthesis Example 1 except that N-methyl glycine methyl ester hydrochloric acid salt was changed to N-methyl glycine isopropyl ester hydrochloric acid salt (reagent, manufactured by Tokyo Chemical Industry Co., Ltd.). Its purity was 98.5 percent by mass.

The molecular weight of N-acryloyl-N-methyl alanine methyl ester (A1-5) was 185.2.

### Synthesis Example 6

### Synthesis of N-acryloyl-N-methyl Alanine Isopropyl Ester (A1-6)

A total of 0.22 mol of the target N-acryloyl-N-methylalanine methyl ester (A1-6) was obtained as an almost colorless and transparent liquid in the same manner as in Synthesis Example 1 except that N-methylglycine methyl ester hydrochloride was changed to N-methylalanine isopropyl ester hydrochloride (reagent, manufactured by Tokyo Chemical Industry Co. Ltd.). Its purity was 98.5 percent by mass.

The molecular weight of N-acryloyl-N-methyl alanine methyl ester (A1-6) was 199.3.

### Synthesis Example 7

### Synthesis of N-acryloyl Piperidine-4-carboxylic Acid Ethyl (A1-7)

A total of 0.27 mol of the target N-acryloylpiperidine-4-carboxylic acid ethyl ester (A1-7) was obtained as an almost colorless and transparent liquid in the same manner as in Synthesis Example 1 except that N-methylglycine methyl ester hydrochloride was changed to piperidine-4-carboxylic acid ethyl (reagent, manufactured by Tokyo Chemical Industry Co. Ltd.). Its purity was 99.2 percent by mass.

N-acryloyl-piperidine-4-ethyl carboxylate (A1-7) has a molecular weight of 211.3 and is a known compound (CAS registration number 845907-79-1).

### Synthesis Example 8

### Synthesis of 5,7-dimethoxy-3-(4-(4-pentylphenyl)benzoyl)coumarin (B-2)

### Synthesis of 4,6-dimethoxy-2-hydroxy-benzaldehyde

A total of 30 g (195 mmole) of 3,5-dimethoxy phenol was added during stirring to 1,000 mL of THF (absolute) containing 17.6 g (582 mmol) of paraform aldehyde (absolute), 53.1 g (525 mmol) of triethylamine (absolute), and 50 g (525 mmol) of magnesium chloride (absolute) in a nitrogen ambient. The resulting mixture was kept at 60 degrees C. for 40 minutes and then cooled down to room temperature followed by dilution with 1,000 mL of water. Thereafter, a total of 1,000 ml of 1N hydrochloric acid was added. The resulting liquid was extracted with ethyl acetate followed by vacuum evaporation of the solvent. The coarse product obtained was purified by silica gel flash chromatography (ethyl acetate to hexane at 1:1) to obtain 16.9 g (yield ratio of 48 percent) of white solid of 4,6-dimethoxy-2-hydroxy benzaldehyde.

Identification Data

¹H-NMR (CDCl3, δ ppm): 3.84 (s, 3H), 3.85 (s, 3H), 5.91 (s, 1H), 6.02 (s, 1H), 10.10 (s, 1H), Synthesis of 5,7-dimethoxy-3-(4-(4-pentylphenyl)benzoyl)coumarin

A total of 10 g (29.5 mmol) of ethyl(4-(4-pentylphenyl)benzoyl)acetate, procured from Chemiliva Pharmaceutical Product List Co., Ltd, and 2.5 g (29.5 mmol) of piperidine were added to a solution of 100 mL of ethanol containing 5.4 g (29.5 mmol) of 4,6-dimethoxy-2-hydroxy-benzaldehyde. The mixture was stirred at reflux for two hours followed by cooling. The resulting solution was subjected to crystallization at room temperature followed by filtering to collect a reaction product. A total of 11.7 g of white crystal was thus obtained (yield ratio: 87 percent).

Identification DATA

¹H-NMR (CDCl₃, δ ppm): 1.12 (t, 3H), 1.44-1.77 (m, 6H), 2.46 (m, 2H), 3.92 (s, 6H), 6.30 (s, 1H), 6.47 (s, 1H), 7.45 (d, 2H), 7.87 (d, 2H), 7.98 (d, 2H), 8.15 (d, 2H), 8.45 (s, 1H)

### Synthesis Example 9

### Synthesis of 5,7-dimethoxy-3-(6-methoxy-2-naphthoyl)coumarin (B-3)

A total of 10 g (29.5 mmol) of ethyl(4-(6-methoxynaphthyl)benzoyl)acetate, procured from Chemiliva Pharmaceutical Product List Co., Ltd, and 2.5 g (29.5 mmol) of piperidine were added to a solution of 100 mL of ethanol containing 5.4 g (29.5 mmol) of 4,6-dimethoxy-2-hydroxy-benzaldehyde. The mixture was stirred at reflux for two hours followed by cooling. The resulting solution was subjected to crystallization at room temperature followed by filtering to collect a reaction product. A total of 10.2 g of white crystal was thus obtained (yield ratio: 74 percent).

Identification Data

¹H-NMR (CDCl₃, δ ppm): 3.62 (s, 6H), 6.30 (s, 1H), 6.47 (s, 1H), 7.51 (m, 2H), 7.61 (d, 1H), 7.98 (m, 4H), 8.15 (d, 2H), 8.45 (s, 1H).

### Example 1

Preparation of Composition

A-1 (20.0 percent by mass), A-2 (20.0 percent by mass), A-3 (10.0 percent by mass), A-4 (9.8 percent by mass), A-6 (10.0 percent by mass), A-13 (5.0 percent by mass), A1-1 (10.0 percent by mass), A1-7 (8.0 percent by mass), B-1 (1.0 percent by mass), C-2 (4.0 percent by mass), C-3 (1.0 percent by mass), D-1 (1.0 percent by mass), a polymerization inhibitor (0.1 percent by mass), and a surfactant (0.1 percent by mass) were sequentially added followed by stirring for two hours. After the liquid obtained was visually confirmed to be free of the materials residue, the solution was filtered with a membrane filter to remove coarse particles. The composition of Example 1 was thus prepared.

### Examples 2 to 30 and Comparative Examples 1 to 10

Active energy ray curable compositions of Examples 2 to 30 and Comparative Examples 1 to 10 were manufactured in the same manner as in Example 1 except that the compositions and the contents (percent by mass) were changed to those shown in Tables 2-1 to 2-4 below.

TABLE 2-1

| Category of | | Example | | | | |
|---|---|---|---|---|---|---|
| component | Component | 1 | 2 | 3 | 4 | 5 |
| Polymerizable | A-1 | 20.0 | 20.0 | 20.0 | 20.0 | 20.0 |
| Compound A | A-2 | 20.0 | 20.0 | 20.0 | 2.0.0 | 20.0 |
| | A-3 | 10.0 | 10.0 | 10.0 | 10.0 | 10.0 |
| | A-4 | 9.8 | | | 4.8 | 10.0 |
| | A-5 | | 9.8 | | | 4.8 |
| | A-6 | 10.0 | | | | |
| | A-7 | | 10.0 | | | |
| | A-8 | | | | | 5.0 |
| | A-9 | | | 4.8 | | |
| | A-10 | | | | | |
| | A-11 | | | 20.0 | 20.0 | |
| | A-12 | | | | | |
| | A-13 | 5.0 | 5.0 | | | |
| | A-14 | | | | | 5.0 |
| | A1-1 | 10.0 | 10.0 | 10.0 | 10.0 | 10.0 |
| | A1-2 | | | | 4.0 | |
| | A1-3 | | | | | 4.0 |
| | A1-4 | | | | | |
| | A1-5 | | | | | |
| | A1-6 | | | | | |
| | A1-7 | 8.0 | 8.0 | 8.0 | | |
| Hydrogen | B-1 | 1.0 | 1.0 | | | |
| abstracting | B-2 | | | 1.0 | 3.0 | |
| polymerization | B-3 | | | | | 3.0 |
| initiator (B) | B1-1 | | | | | |
| | B1-2 | | | | | |
| Photodegradable | C-1 | | | | | |
| polymerization | C-2 | 4.0 | 4.0 | | 2.0 | 2.0 |
| initiator (C) | C-3 | 1.0 | 1.0 | 1.0 | 3.0 | 3.0 |
| | C-4 | | | | | |
| | C-5 | | | | | |
| | C-6 | | | 4.0 | | |
| | D-1 | 1.0 | 1.0 | 1.0 | | |
| Hydrogen | D-2 | | | | 3.0 | 3.0 |
| donor (D) | D-3 | | | | | |
| | D-4 | | | | | |
| | D-5 | | | | | |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

| Category of | | Example | | | | |
|---|---|---|---|---|---|---|
| component | Component | 6 | 7 | 8 | 9 | 10 |
| Polymerizable | A-1 | 20.0 | 20.0 | 20.0 | 20.0 | 20.0 |
| Compound A | A-2 | 20.0 | 20.0 | 20.0 | 20.0 | 20.0 |
| | A-3 | 10.0 | 10.0 | 10.0 | 10.0 | 10.0 |
| | A-4 | | | | | |
| | A-5 | 10.0 | | | 10.0 | |
| | A-6 | 4.8 | 10.0 | | | 10.0 |
| | A-7 | | 4.8 | 10.0 | | |
| | A-8 | 5.0 | | 4.8 | | |
| | A-9 | | | | 10.0 | 10.0 |
| | A-10 | | 10.0 | 10.0 | | |
| | A-11 | | | | | |
| | A-12 | | | | 4.8 | 4.8 |
| | A-13 | | | | | |
| | A-14 | 5.0 | | | | |
| | A1-1 | 10.0 | 10.0 | 10.0 | 10.0 | 10.0 |
| | A1-2 | | | | | |
| | A1-3 | | | | | |
| | A1-4 | 4.0 | | | | |
| | A1-5 | | 2.0 | 2.0 | | |
| | A1-6 | | | | 2.0 | |
| | A1-7 | | | | | |
| Hydrogen | B-1 | | 5.0 | 5.0 | 5.0 | 5.0 |
| abstracting | B-2 | | | | | |
| polymerization | B-3 | 3.0 | | | | |
| initiator (B) | B1-1 | | | | | |
| | B1-2 | | | | | |
| Photodegradable | C-1 | | | | | |
| polymerization | C-2 | 2.0 | 1.0 | 1.0 | 1.0 | |
| initiator (C) | C-3 | | 2.0 | 2.0 | 2.0 | |
| | C-4 | | | | | 5.0 |
| | C-5 | | | | | |
| | C-6 | 3.0 | | | | |
| Hydrogen | D-1 | | | | | |
| donor (D) | D-2 | 3.0 | | | | |
| | D-3 | | 5.0 | 5.0 | 5.0 | |
| | D-4 | | | | | 4.0 |
| | D-5 | | | | | 1.0 |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

TABLE 2-2

| Category of | | Example | | | | |
|---|---|---|---|---|---|---|
| component | Component | 11 | 12 | 13 | 14 | 15 |
| Polymerizable | A-1 | 20.0 | 20.0 | 18.0 | 20.0 | 20.0 |
| compound (A) | A-2 | 20.0 | 18.0 | 20.0 | 20.0 | 20.0 |
| | A-3 | 10.0 | 10.0 | 10.0 | 10.0 | 10.0 |
| | A-4 | 9.8 | | | 4.8 | 10.0 |
| | A-5 | | 9.8 | | | 4.8 |
| | A-6 | 10.0 | | | 2.0 | |
| | A-7 | | 10.0 | | | 2.0 |
| | A-8 | | | | | 5.0 |
| | A-9 | | | 4.8 | | |
| | A-10 | | | | | |
| | A-11 | | | 20.0 | 20.0 | |
| | A-12 | | | | | |
| | A-13 | 5.0 | 5.0 | | | |
| | A-14 | | | | | 5.0 |
| | A1-1 | 10.0 | 10.0 | 10.0 | 10.0 | 10.0 |
| | A1-2 | | | | 4.0 | |
| | A1-3 | | | | | 4.0 |
| | A1-4 | | | | | |
| | A1-5 | | | | | |
| | A1-6 | | | | | |
| | A1-7 | 6.0 | 8.0 | 8.0 | | |
| Hydrogen | B-1 | 0.5 | 0.5 | 0.5 | 0.5 | 0.5 |
| abstracting | B-2 | | | | | |
| polymerization | B-3 | | | | | |
| initiator (B) | B1-1 | | | | | |
| | B1-2 | | | | | |
| Photodegradable | C-1 | | | | | 2.0 |
| polymerization | C-2 | 3.0 | | | | |
| initiator (C) | C-3 | 5.0 | 8.0 | | | 6.0 |
| | C-4 | | | 8.0 | 6.0 | |
| | C-5 | | | | 2.0 | |
| | C-6 | | | | | |
| Hydrogen | D-1 | 0.5 | 0.5 | | | |
| donor (D) | D-2 | | | 0.5 | 0.5 | |
| | D-3 | | | | | 0.5 |
| | D-4 | | | | | |
| | D-5 | | | | | |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

| Category of | | Example | | | | |
|---|---|---|---|---|---|---|
| component | Component | 16 | 17 | 18 | 19 | 20 |
| Polymerizable | A-1 | 20.0 | 20.0 | 20.0 | 20.0 | 20.0 |
| compound (A) | A-2 | 20.0 | 20.0 | 20.0 | 20.0 | 20.0 |
| | A-3 | 10.0 | 10.0 | 10.0 | 10.0 | 10.0 |
| | A-4 | | | | | |
| | A-5 | 10.0 | | | 10.0 | |
| | A-6 | 4.8 | 10.0 | | | 10.0 |
| | A-7 | | 4.8 | 10.0 | | |
| | A-8 | 5.0 | | 4.8 | | |
| | A-9 | | | | 10.0 | 10.0 |
| | A-10 | | 10.0 | 10.0 | | |
| | A-11 | | | | | |
| | A-12 | | | | 4.8 | 4.8 |
| | A-13 | | 2.6 | | | |
| | A-14 | 5.0 | | 2.6 | | |
| | A1-1 | 10.0 | 10.0 | 10.0 | 10.0 | 10.0 |
| | A1-2 | | | | | |
| | A1-3 | | | | 5.0 | |
| | A1-4 | 4.0 | | | | 4.0 |
| | A1-5 | | 2.0 | 2.0 | | |
| | A1-6 | | | | 2.0 | |
| | A1-7 | | | | | |
| Hydrogen | B-1 | 0.5 | 0.2. | 0.2 | 0.5 | 0.5 |
| abstracting | B-2 | | | | | |
| polymerization | B-3 | | | | | |
| initiator (B) | B1-1 | | | | | |
| | B1-2 | | | | | |
| Photodegradable | C-1 | | | | | 2.0 |
| polymerization | C-2 | | | 5.0 | 7.0 | |
| initiator (C) | C-3 | 10.0 | | 5.0 | | |
| | C-4 | | | | | 5.0 |
| | C-5 | | | | | 3.0 |
| | C-6 | | 10.0 | | | |
| Hydrogen | D-1 | | 0.2 | 0.2 | 0.2 | 0.2 |
| donor (D) | D-2 | | | | 0.1 | |
| | D-3 | 0.5 | | | 0.2 | 0.1 |
| | D-4 | | | | | 0.1 |
| | D-5 | | | | | 0.1 |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

TABLE 2-3

| Category of | | Example | | | | |
|---|---|---|---|---|---|---|
| component | Component | 21 | 22 | 23 | 24 | 25 |
| Polymerizable | A-1 | 20.0 | 20.0 | 20.0 | 20.0 | 20.0 |
| compound (A) | A-2 | 20.0 | 20.0 | 20.0 | 20.0 | 20.0 |
| | A-3 | 10.0 | 10.0 | 10.0 | 10.0 | 10.0 |
| | A-4 | 9.8 | | | 4.8 | 10.0 |
| | A-5 | | 9.8 | | 6.0 | 4.8 |
| | A-6 | 10.0 | | 7.0 | 6.0 | |
| | A-7 | | 10.0 | | | |
| | A-8 | | | | | 5.0 |
| | A-9 | 6.0 | | 4.8 | | |
| | A-10 | 6.0 | 7.0 | | | |
| | A-11 | | | 20.0 | 20.0 | |
| | A-12 | | | | | |
| | A-13 | 5.0 | 5.0 | | | 7.0 |
| | A-14 | | | | | 5.0 |
| | A1-1 | | | | | |
| | A1-2 | | | | | |
| | A1-3 | | | | | |
| | A1-4 | | | | | |
| | A1-5 | | | | | |
| | A1-6 | | | | | |
| | A1-7 | | | | | |
| Hydrogen | B-1 | 2.0 | 2.0 | | | |
| abstracting | B-2 | | | 2.0 | 2.0 | |
| polymerization | B-3 | | | | | 2.0 |
| initiator (B) | B1-1 | | | | | |
| | B1-2 | | | | | |
| Photodegradable | C-1 | | | | | |
| polymerization | C-2 | | | 5.0 | | |
| initiator (C) | C-3 | 10.0 | 15.0 | 10.0 | | |
| | C-4 | | | | | |
| | C-5 | | | | | |
| | C-6 | | | | 10.0 | 15.0 |
| Hydrogen | D-1 | 1.0 | 1.0 | 1.0 | | |
| donor (D) | D-2 | | | | 1.0 | 1.0 |
| | D-3 | | | | | |
| | D-4 | | | | | |
| | D-5 | | | | | |
| Polymerization inhibitor | | 0.1 | 0.1 | 0.1 | 0.1 | 0.1 |
| Surfactant | | 0.1 | 0.1 | 0.1 | 0.1 | 0.1 |
| Sum of compositions above | | 100.0 | 100.0 | 100.0 | 100.0 | 100.0 |
| Category of | | Example | | | | |
| component | Component | 26 | 27 | 28 | 29 | 30 |
| Polymerizable | A-1 | 20.0 | 20.0 | 20.0 | 20.0 | 20.0 |
| compound (A) | A-2 | 20.0 | 20.0 | 20.0 | 20.0 | 20.0 |
| | A-3 | 10.0 | 10.0 | 10.0 | 10.0 | 10.0 |
| | A-4 | | | 6.0 | | |
| | A-5 | 10.0 | | | 10.0 | |
| | A-6 | 4.8 | 10.0 | | | 10.0 |
| | A-7 | | 4.8 | 10.0 | 6.0 | |
| | A-8 | 5.0 | | 4.8 | | 6.0 |
| | A-9 | | | | 10.0 | 10.0 |
| | A-10 | | 10.0 | 10.0 | | |
| | A-11 | | 7.0 | | | 6.0 |
| | A-12 | 7.0 | | | 4.8 | 4.8 |
| | A-13 | | | | 6.0 | |
| | A-14 | 5.0 | | 6.0 | | |
| | A1-1 | | | | | |
| | A1-2 | | | | | |
| | A1-3 | | | | | |
| | A1-4 | | | | | |
| | A1-5 | | | | | |
| | A1-6 | | | | | |
| | A1-7 | | | | | |
| Hydrogen | B-1 | | 2.0 | 2.0 | 2.0 | 2.0 |
| abstracting | B-2 | | | | | |
| polymerization | B-3 | 2.0 | | | | |
| initiator (B) | B1-1 | | | | | |
| | B1-2 | | | | | |
| Photodegradable | C-1 | 5.0 | | | | |
| polymerization | C-2 | | | | | |
| initiator (C) | C-3 | 10.0 | 10.0 | | | |
| | C-4 | | | 10.0 | 10.0 | 10.0 |
| | C-5 | | 5.0 | | | |
| | C-6 | | | | | |
| Hydrogen | D-1 | | | | | |
| donor (D) | D-2 | 1.0 | | | | |
| | D-3 | | 1.0 | 1.0 | | |
| | D-4 | | | | 1.0 | |
| | D-5 | | | | | 1.0 |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

TABLE 2-4

| | | Comparative Example | | | | |
|---|---|---|---|---|---|---|
| yo | Component | 1 | 2 | 3 | 4 | 5 |
| Polymerizable | A-1 | 20.0 | 20.0 | 20.0 | 20.0 | 20.0 |
| compound (A) | A-2 | 20.0 | 20.0 | 20.0 | 20.0 | 20.0 |
| | A-3 | 10.0 | 10.0 | 10.0 | 10.0 | 10.0 |
| | A-4 | 9.8 | | | 4.8 | 10.0 |
| | A-5 | | 9.8 | | 3.0 | 4.8 |
| | A-6 | 10.0 | | | | 6.0 |
| | A-7 | | 10.0 | | | |
| | A-8 | | | | | 5.0 |
| | A-9 | | | 4.8 | | |
| | A-10 | | | | | |
| | A-11 | | | 19.0 | 20.0 | |
| | A-12 | | | | | |
| | A-13 | 5.0 | 5.0 | | | |
| | A-14 | | | | | 5.0 |
| | A1-1 | 4.0 | 4.0 | 10.0 | 10.0 | 10.0 |
| | A1-2 | | | | 4.0 | |
| | A1-3 | | | | | 4.0 |
| | A1-4 | | | | | |
| | A1-5 | | | | | |
| | A1-6 | | | | | |
| | A1-7 | 8.0 | 8.0 | 8.0 | | |
| Hydrogen | B-1 | 3.0 | | | | |
| abstracting | B-2 | | 3.0 | | | |
| polymerization | B-3 | | | | | |
| initiator (B) | B1-1 | | | | | |
| | B1-2 | | | | | |
| Photodegradable | C-1 | | | | | |
| polymerization | C-2 | | 5.0 | | | |
| initiator (C) | C-3 | 10.0 | 5.0 | 5.0 | | |
| | C-4 | | | | | |
| | C-5 | | | | | |
| | C-6 | | | | 5.0 | 5.0 |
| Hydrogen | D-1 | | | 3.0 | | |
| donor (D) | D-2 | | | | 3.0 | |
| | D-3 | | | | | |
| | D-4 | | | | | |
| | D-5 | | | | | |
| Polymerization inhibitor | | 0.1 | 0.1 | 0.1 | 0.1 | 0.1 |
| Surfactant | | 0.1 | 0.1 | 0.1 | 0.1 | 0.1 |
| Sum of compositions above | | 100.0 | 100.0 | 100.0 | 100.0 | 100.0 |
| | | Comparative Example | | | | |
| yo | Component | 6 | 7 | 8 | 9 | 10 |
| Polymerizable | A-1 | 10.0 | 15.0 | 18.0 | 20.0 | 20.0 |
| compound (A) | A-2 | 16.0 | 15.0 | 10.0 | 20.0 | 20.0 |
| | A-3 | 10.0 | 8.0 | 10.0 | 10.0 | 10.0 |
| | A-4 | | | | | |
| | A-5 | 10.0 | | | 10.0 | |
| | A-6 | 4.8 | 10.0 | | 7.0 | 10.0 |
| | A-7 | | 4.8 | 10.0 | | 6.0 |
| | A-8 | 5.0 | | 4.8 | | 3.0 |
| | A-9 | | | | 10.0 | 10.0 |
| | A-10 | | 10.0 | 10.0 | | |
| | A-11 | | | | | |
| | A-12 | | | | 4.8 | 4.8 |
| | A-13 | | | | | |
| | A-14 | 5.0 | | | | |
| | A1-1 | 10.0 | 10.0 | 10.0 | 10.0 | 10.0 |
| | A1-2 | | | | | |
| | A1-3 | | | | | |
| | A1-4 | 4.0 | | | | |
| | A1-5 | | 2.0 | 2.0 | | |
| | A1-6 | | | | 2.0 | |
| | A1-7 | | | | | |
| Hydrogen | B-1 | 10.0 | | | 3.0 | 3.0 |
| abstracting | B-2 | | | | | |
| polymerization | B-3 | | 20.0 | | | |
| initiator (B) | B1-1 | | | | | |
| | B1-2 | | | | | |
| Photodegradable | C-1 | | | 5.0 | | |
| polymerization | C-2 | | | | | |
| initiator (C) | C-3 | | | | | |
| | C-4 | | | | | |
| | C-5 | 5.0 | 5.0 | | | |
| | C-6 | | | | | |
| Hydrogen | D-1 | 10.0 | | | | |
| donor (D) | D-2 | | | 20.0 | 3.0 | 3.0 |
| | D-3 | | | | | |
| | D-4 | | | | | |
| | D-5 | | | | | |

| | | | | | |
|---|---|---|---|---|---|
| Polymerization inhibitor | 0.1 | 0.1 | 0.1 | 0.1 | 0.1 |
| Surfactant | 0.1 | 0.1 | 0.1 | 0.1 | 0.1 |
| Sum of compositions above | 100.0 | 100.0 | 100.0 | 100.0 | 100.0 |

Viscosity, curability, hardness, and yellowing of each of the obtained compositions were evaluated as follows. The results are shown in Tables 3-1 and 3-4.

Measuring of Viscosity

The viscosity of the compositions was measured by a cone plate type rotatory viscometer (VISCOMETER TVE-22L, manufactured by TOKI SANGYO CO., LTD.) using a cone plate rotor (1°34′×R24) at a rate of rotation of 50 rpm and hemathermal circulating water at 25 degrees C. The temperature of the circulating water was controlled with a VISCOMATE VM-150III.

Formation of Print Image by Inkjet

Each composition was filled in a plastic composition container, and mounted onto a device for forming an image including an inkjet head (MH5440, manufactured by Ricoh Co., Ltd.) as a discharging device, and a UV-LED (LED ZERO, wavelength of 395 nm, illuminance at irradiation surface of 1.0 W/cm², manufactured by Integration Technology Japan) as an active energy ray irradiator, a controller for controlling discharging, and a supply path from the composition container to the inkjet head.

The temperature of the inkjet head was adjusted to achieve a viscosity of the composition of from 10 to 12 mPa·s. The composition was inkjetted onto a procured PET film (Cosmo Shine A4100, thickness of 188 μm, manufactured by TOYOBO CO., LTD.) as a general-purpose film material to form a film having a thickness of 10 μm followed by irradiation of ultraviolet radiation with a UV-LED to create a printed image.

Curability

Film confirmed as not sticky by finger-touching was determined as cured and the integrated irradiation light quantity required for curing was obtained. The results are shown in Tables 3-1 and 3-4. The composition was determined suitable for a practical purpose when the cumulative irradiation light quantity required to cure was 1.0 J/cm² or less.

Hardness

The hardness of the obtained cured matter was measured according to JIS K5600-5-4 format, scratch hardness (pencil method) and evaluated based on the following evaluation criteria. The results are shown in Tables 3-1 to 3-4. The pencil hardness HB or above was determined as suitable for a practical purpose.

Yellowing

A print sample obtained by the method described in the Formation of Print Image by Inkjet was cut into a square of 5 cm, which was subjected to Gretag measurement with a Gretag measuring device (Ci6x, manufactured by X-Rite Inc.). The evaluation results are shown in Tables 3-1 to 3-4. In the following evaluation based on b*, Grade C or above is usable for practical purpose.

Evaluation Criteria

A: b* is 1 or less
B: b* is greater than 1 to 2
C: b* is greater than 2 to 4
D: b* is greater than 4

Device and Instrument

Device: Pencil scratch hardness TQC WW tester (specialized for load of 750 g) (manufactured by COTEC Corporation)

Pencil: Set of pencils (Mitsubishi Pencil Co., Ltd.) made of wood for drawing and having the following hardness

6B, 5B, 4B, 3B, 2B, B, HB, F, H, 2H, 3H, 4H, 5H, and 6H

Pencil sharpener: Special device that scrapes off the wood part alone of a pencil while leaving the cylinder-like core of the pencil as is.

Ink having a poor curability does not cure sufficiently upon an application of the quantity of light mentioned above so that the resulting hardness is low.

TABLE 3-1

| Evaluation | Example | | | | |
|---|---|---|---|---|---|
| item | 1 | 2 | 3 | 4 | 5 |
| Cumulative | 0.2 | 0.2 | 0.3 | 0.3 | 0.3 |
| irradiance | | | | | |
| required for | | | | | |
| curing (J/cm²) | | | | | |
| Yellowing | A | A | A | A | A |
| Pencil | H | H | H | H | H |
| hardness | | | | | |
| Viscosity | 11.5 | 11.6 | 11.8 | 12.2 | 11.8 |
| Evaluation | Example | | | | |
| item | 6 | 7 | 8 | 9 | 10 |
| Cumulative | 0.2 | 0.2 | 0.2 | 0.3 | 0.3 |
| irradiance | | | | | |
| required for | | | | | |
| curing (J/cm²) | | | | | |
| Yellowing | A | A | A | A | A |
| Pencil | H | H | H | H | H |
| hardness | | | | | |
| Viscosity | 11.8 | 12.1 | 12.6 | 13.1 | 12.2 |

TABLE 3-2

| Evaluation | Example | | | | |
|---|---|---|---|---|---|
| item | 11 | 12 | 13 | 14 | 15 |
| Cumulative | 0.9 | 0.9 | 0.8 | 1.0 | 0.8 |
| irradiance | | | | | |
| required for | | | | | |
| curing (J/cm²) | | | | | |
| Yellowing | A | A | A | A | A |
| Pencil | F | F | F | HB | HB |
| hardness | | | | | |
| Viscosity | 14.5 | 13.2 | 16.7 | 16.4 | 15.4 |
| Evaluation | Example | | | | |
| item | 16 | 17 | 18 | 19 | 20 |
| Cumulative | 0.9 | 0.8 | 0.9 | 0.9 | 0.9 |
| irradiance | | | | | |
| required for | | | | | |
| curing (J/cm²) | | | | | |
| Yellowing | A | A | A | A | A |
| Pencil | F | HB | HB | F | F |
| hardness | | | | | |
| Viscosity | 14.9 | 15.0 | 16.2 | 14.7 | 17.0 |

TABLE 3-3

| Evaluation | Example | | | | |
|---|---|---|---|---|---|
| item | 21 | 22 | 23 | 24 | 25 |
| Cumulative | 0.4 | 0.4 | 0.5 | 0.4 | 0.6 |
| irradiance | | | | | |
| required for | | | | | |
| curing (J/cm²) | | | | | |
| Yellowing | A | B | B | A | B |
| Pencil | HB | HB | HB | HB | HB |
| hardness | | | | | |
| Viscosity | 19.5 | 19.3 | 17.7 | 18.2 | 20.8 |
| Evaluation | Example | | | | |
| item | 26 | 27 | 28 | 29 | 30 |
| Cumulative | 0.5 | 0.6 | 0.4 | 0.4 | 0.5 |
| irradiance | | | | | |
| required for | | | | | |
| curing (J/cm²) | | | | | |
| Yellowing | B | A | B | B | B |
| Pencil | HB | HB | HB | HB | HB |
| hardness | | | | | |
| Viscosity | 20.5 | 19.8 | 21.5 | 23.1 | 22.2 |

TABLE 3-4

| Evaluation | Comparative Example | | | | |
|---|---|---|---|---|---|
| item | 1 | 2 | 3 | 4 | 5 |
| Cumulative | *1 | *1 | *1 | *1 | *1 |
| irradiance | | | | | |
| required for | | | | | |
| curing (J/cm²) | | | | | |
| Yellowing | — | — | — | — | — |
| Pencil | — | — | — | — | — |
| hardness | | | | | |
| Viscosity | 17.7 | 16.5 | 18.1 | 19.3 | 14.6 |
| Evaluation | Comparative Example | | | | |
| item | 6 | 7 | 8 | 9 | 10 |
| Cumulative | 3.8 | 5.7 | 4.5 | *1 | *1 |
| irradiance | | | | | |
| required for | | | | | |
| curing (J/cm²) | | | | | |
| Yellowing | D | D | D | — | — |
| Pencil | 5B | 4B | 4B | — | — |
| hardness | | | | | |
| Viscosity | 46.6 | 44.4 | 45.6 | 12.6 | 18.4 |

“*1” in the column of Cumulative irradiance required for curing (J/cm²) of Comparative Examples 1 to 5, 9, and 10 in Table 3-4 means that the composition did not cure at exposure to a cumulative irradiance of 100 J/cm².
“—” about yellowing and pencil hardness of Comparative Examples 1 to 5, 9, and 10 in Table 3-4 means that they were not measurable because the composition did not cure.

The present disclosure is related to the curable composition of the following 1 and also includes the following 2 to 15 as embodiments.

The curable composition contains a polymerizable compound (A), a hydrogen abstracting polymerization initiator (B) represented by the following Chemical Formula 1, a photodegradable polymerization initiator (C), and a hydrogen donor (D). The proportion of the hydrogen abstracting polymerization initiator (B) to the entire of the curable composition is from 0.1 to 10 percent by mass and the proportion of the hydrogen donor (D) to the entire of the hydrogen abstracting polymerization initiator (B) is from 30 to 100 percent by mass.

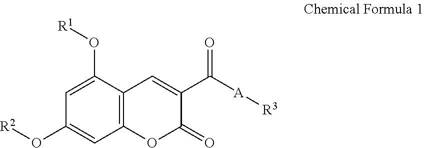

In Chemical Formula 1, A represents a phenylene group, naphthylene group, or biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

2. The curable composition according to 1 mentioned above, wherein the proportion of the sum of the hydrogen abstracting polymerization initiator (B) and the hydrogen donor (D) to the entire of the curable composition is 10 percent by mass or less.

3. The curable composition according to 1 or 2 mentioned above, wherein the hydrogen donor (D) is represented by the following Chemical Formula 2 or Chemical Formula 3.

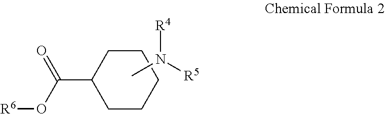

In Chemical Formula 2, R⁴ and R⁵ each, independently represent hydrogen atoms or linear or branched alkyl groups having 1 to 4 carbon atoms and R represents a linear or branched alkyl group having 1 to 10 carbon atoms.

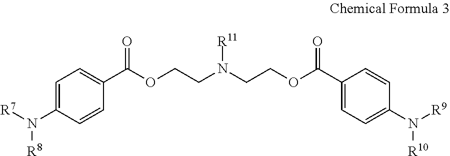

In Chemical Formula 3, R⁷, R⁸, R⁹, and R¹⁰ each, independently represent hydrogen atoms or linear or branched alkyl groups having 1 to 4 carbon atoms and R¹¹ represents a linear or branched alkyl group having 1 to 10 carbon atoms.

4. The curable composition according to any one of 1 to 3, wherein the polymerizable compound (A) comprises an acrylamide compound (A1) represented by the following Chemical Formula 4 or Chemical Formula 5,

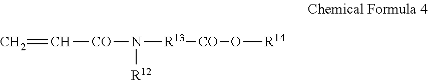

In Chemical Formula 4, R¹² represents a hydrogen atom or a linear or branched alkyl group having 1 to 4 carbon atoms, R¹³ represents a linear or branched alkylene group having 1 to 4 carbon atoms, R¹⁴ represents a linear or branched alkyl group having 1 to 4 carbon atoms. The total number of carbon atoms of R¹², R¹³, and R¹⁴ is from two to six,

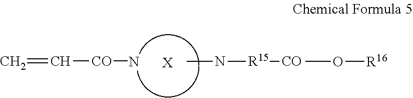

In Chemical Formula 5, the ring X represents a ring structure having 2 to 5 carbon atoms including a nitrogen atom, R¹⁵ represents a single bond or a linear or branched alkylene group having 1 to 3 carbon atoms, R¹⁶ represents a linear or branched alkyl group having 1 to 3 carbon atoms. In Chemical Formula 5, the total number of the carbon atoms of the ring X, R¹⁵, and R¹⁶ is from three to six.

5. The curable composition according to any one of 1 to 4, wherein the proportion of the photodegradable polymerization initiator (C) to the entire of the curable composition is from 3 to 20 percent by mass, wherein the proportion of the sum of the hydrogen abstracting polymerization initiator (B) and the hydrogen donor (D) to the entire of the curable composition is 2 percent by mass or less.

6. The curable composition according to any one of 1 to 5 mentioned above, being free of an organic solvent.

7. A curable ink contains the curable composition of any one of 1 to 6 mentioned above.

8. The curable ink according to 7 mentioned above, wherein the curable ink is inkjet ink.

9. A composition container contains the curable composition of any one of 1 to 6 mentioned above or the curable ink of 7 or 8 mentioned above and a container containing the curable composition or the curable ink.

10. A device for forming a two-dimensional or three-dimensional image includes either or both of the curable composition of any one of 1 to 6 mentioned above or the curable ink of 7 or 8 mentioned above, an accommodating unit accommodating the curable composition either or both of the curable composition and the curable ink and an irradiator for irradiating either or both of the curable composition and the curable ink.

11. The device according to 10 mentioned above, wherein the irradiator includes an ultraviolet light emitting diode that emits ultraviolet radiation having a peak in a wavelength range of from 365 to 405 nm.

12. A method of forming a two-dimensional or three-dimensional image includes applying active energy radiation to the curable composition of any one of 1 to 6 mentioned above or the curable ink of 7 or 8 mentioned above to form a two-dimensional image or three-dimensional image.

13. The method according to 12 mentioned above, wherein the applying is conducted with an irradiator including an ultraviolet light emitting diode that emits ultraviolet radiation having a peak in a wavelength range of from 365 to 405 nm.

14. Cured matter of the curable composition of any one of 1 to 6 mentioned above or the curable ink of 7 or 8 mentioned above.

15. A decorative object includes a substrate and

a surface decoration containing the cured matter of 14 mentioned above on the substrate.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A curable composition comprising:
a polymerizable compound (A);
a hydrogen abstracting polymerization initiator (B) represented by the following Chemical Formula 1;
a photodegradable polymerization initiator (C); and
a hydrogen donor (D),
wherein a proportion of the hydrogen abstracting polymerization initiator (B) to an entire of the curable composition is from 0.1 to 10 percent by mass,
wherein a proportion of the hydrogen donor (D) to an entire of the hydrogen abstracting polymerization initiator (B) is from 30 to 100 percent by mass, 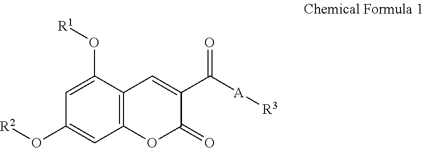
where A represents a phenylene group, a naphthylene group, or a biphenylene group, R¹ and R² each, independently represent linear or branched alkyl groups having 1 to 10 carbon atoms, R³ represents a linear or branched alkyl group having 1 to 10 carbon atoms or a linear or branched alkoxy group having 2 to 9 carbon atoms.

2. The curable composition according to claim 1, wherein a proportion of a sum of the hydrogen abstracting polymerization initiator (B) and the hydrogen donor (D) to the entire of the curable composition is 10 percent by mass or less.

3. The curable composition according to claim 1, wherein the hydrogen donor (D) is represented by the following Chemical Formula 2 or Chemical Formula 3, 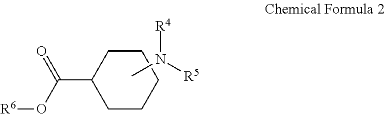
in Chemical Formula 2, R⁴ and R⁵ each, independently represent hydrogen atoms or linear or branched alkyl groups having 1 to 4 carbon atoms and R⁶ represents a linear or branched alkyl group having 1 to 10 carbon atoms, 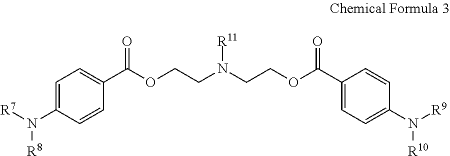
in Chemical Formula 3, R⁷, R⁸, R⁹, and R¹⁰ each, independently represent hydrogen atoms or linear or branched alkyl groups having 1 to 4 carbon atoms and R¹¹ represents a linear or branched alkyl group having 1 to 10 carbon atoms.

4. The curable composition according to claim 1, wherein the polymerizable compound (A) comprises an acrylamide compound (A1) represented by the following Chemical Formula 4 or Chemical Formula 5, 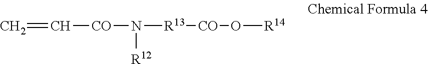
in Chemical Formula 4, R¹² represents a hydrogen atom or a linear or branched alkyl group having 1 to 4 carbon atoms, R¹³ represents a linear or branched alkylene group having 1 to 4 carbon atoms, R¹⁴ represents a linear or branched alkyl group having 1 to 4 carbon atoms, and a total number of carbon atoms of R¹², R¹³, and R¹⁴ is from 2 to 6, 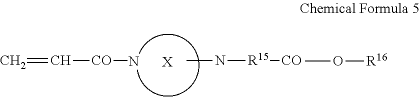
in Chemical Formula 5, a ring X represents a ring structure having 2 to 5 carbon atoms including a nitrogen atom, R¹⁵ represents a single bond or a linear or branched alkylene group having 1 to 3 carbon atoms, R¹⁶ represents a linear or branched alkyl group having 1 to 3 carbon atoms, and a total number of the carbon atoms of the ring X, R¹⁵, and R¹⁶ is 3 to 6.

5. The curable composition according to claim 1, wherein a proportion of the photodegradable polymerization initiator (C) to the entire of the curable composition is from 3 to 20 percent by mass, wherein a proportion of a sum of the hydrogen abstracting polymerization initiator (B) and the hydrogen donor (D) to the entire of the curable composition is 2 percent by mass or less.

6. The curable composition according to claim 1 being free of an organic solvent.

7. A curable ink comprising:
the curable composition of claim 1.

8. The curable ink according to claim 7, wherein the curable ink comprises inkjet ink.

9. A composition container comprising:
the curable composition of claim 1; and
a container containing the curable composition.

10. A device for forming a two-dimensional or three-dimensional image, comprising:
the curable composition of claim 1;
an accommodating unit accommodating the curable composition 1; and
an irradiator configured to irradiate the curable composition with active energy radiation.

11. The device according to claim 10, wherein the irradiator includes an ultraviolet light emitting diode that emits ultraviolet radiation having a peak in a wavelength range of from 365 to 405 nm.

12. A method of forming a two-dimensional or three-dimensional image, comprising:
irradiating the curable composition of claim 1 with active energy radiation to form a two-dimensional image or three-dimensional image.

13. The method according to claim 12, wherein the irradiating is conducted with an irradiator including an ultraviolet light emitting diode that emits ultraviolet radiation having a peak in a wavelength range of from 365 to 405 nm.

14. Cured matter of the curable composition of claim 1.

15. A decorative object comprising:
a substrate; and
a surface decoration comprising the cured matter of claim 14 on the substrate.
